(19) United States
(12) Patent Application Publication
(10) Pub. No.: US 2024/0339588 A1
(43) Pub. Date: Oct. 10, 2024

(54) HONEYCOMB-TYPE CERAMIC POSITIVE ELECTRODE AND LITHIUM-ION SECONDARY BATTERY PROVIDED WITH SAME

(71) Applicant: NGK INSULATORS, LTD., Nagoya-City (JP)

(72) Inventors: Daisuke IIDA, Kitanagoya-City (JP); Eiji NAKASHIMA, Nagoya-City (JP); Nobuyuki KOBAYASHI, Nagoya-City (JP)

(73) Assignee: NGK INSULATORS, LTD., Nagoya-City (JP)

(21) Appl. No.: 18/745,019

(22) Filed: Jun. 17, 2024

Related U.S. Application Data
(63) Continuation of application No. PCT/JP2022/044429, filed on Dec. 1, 2022.

(30) Foreign Application Priority Data
Dec. 23, 2021 (JP) 2021-210000

(51) Int. Cl. H01M 4/131; H01M 4/02; H01M 4/133; H01M 10/0525; H01M 50/434

(52) U.S. Cl. CPC H01M 4/131; H01M 4/133; H01M 10/0525; H01M 50/434; H01M 2004/027; H01M 2004/028

(57) ABSTRACT

Provided is a honeycomb-type ceramic positive electrode having a columnar honeycomb structure, having a first end face, a second end face parallel to the first end face, and an outer side face perpendicular to the first end face and the second end face, and also having a plurality of holes extending from the first end face to the second end face. The honeycomb-type ceramic positive electrode is composed of a lithium complex oxide sintered body in which a plurality of primary grains composed of a lithium complex oxide are bonded, and when a central axis of the columnar honeycomb structure parallel to the outer side face or an axis parallel thereto is defined as a z-axis, the plurality of primary grains are oriented in a z-axis direction.

### CROSS-REFERENCE TO RELATED APPLICATIONS

This application is a continuation application of PCT/JP2022/044429 filed Dec. 1, 2022, which claims priority to Japanese Patent Application No. 2021-210000 filed Dec. 23, 2021, the entire contents all of which are incorporated herein by reference.

### BACKGROUND OF THE INVENTION

### 1. Field of the Invention

The present invention relates to a honeycomb-type ceramic positive electrode and a lithium-ion secondary battery having the same.

### 2. Description of the Related Art

Lithium-ion secondary batteries are widely used in various devices that require charging. In many existing lithium-ion secondary batteries, a powder-dispersed positive electrode (so-called coated electrode) produced by applying and drying a positive electrode mixture containing a positive electrode active material, a conductive additive, a binder, or the like is adopted.

In general, a powder-dispersed positive electrode contains a relatively large amount (e.g., about 10 wt %) of components (such as binders and conductive additives) that do not contribute to the capacity and thus has a low packing density of the lithium complex oxide as the positive electrode active material. Accordingly, the powder-dispersed positive electrode should be greatly improved from the viewpoint of the capacity and charge/discharge efficiency. Some attempts have been made to improve the capacity and charge/discharge efficiency by positive electrodes or layers of positive electrode active material composed of lithium complex oxide sintered plate. In this case, since the positive electrode or the positive electrode active material layer does not contain binders or conductive additives (e.g., conductive carbons), it is expected to have high capacity and good charge/discharge efficiency due to high packing density of the lithium complex oxide. For example, Patent Literature 1 (JP5587052B) discloses a positive electrode of a lithium-ion secondary battery, which has a positive electrode current collector and a positive electrode active material layer bonded to the positive electrode current collector via a conductive bonding layer. The positive electrode active material layer is composed of a lithium complex oxide sintered plate with a thickness of 30 μm or more, a porosity of 3 to 30%, and an open pore rate of 70% or more. Also, Patent Literature 2 (JP6374634B) discloses a lithium complex oxide sintered plate such as lithium cobaltate LiCoO₂ (which will be hereinafter referred to as LCO) that is used for a positive electrode of a lithium-ion secondary battery. This lithium complex oxide sintered plate has a structure in which a plurality of primary grains having a layered rock salt structure are bonded and a porosity of 3 to 40%, a mean pore diameter of 15 μm or less, an open pore rate of 70% or more, a thickness of 15 to 200 μm, and a primary grain size that is the average grain size of the plurality of primary grains of 20 μm or less. In addition, the lithium complex oxide sintered plate has an average of the angles defined by the (003) planes of the plurality of primary grains and the plate face of the lithium complex oxide sintered plate, that is, a mean tilt angle of more than 0° to 30° or less.

A lithium-ion secondary battery using such lithium complex oxide sintered plates has also been proposed. For example, Patent Literature 3 (WO2019/187913A1) discloses a lithium-ion secondary battery having a positive electrode plate that is a lithium complex oxide sintered plate, a negative electrode layer containing carbon, a separator, and an electrolytic solution, in which a plurality of primary grains constituting the lithium complex oxide sintered plate are oriented at an average orientation angle of over 0° and 30° or less with respect to the plate face of the positive electrode plate.

By the way, a secondary battery having a honeycomb-type electrode has been proposed. For example, Patent Literature 4 (JP2020-155334A) discloses a secondary battery having a first electrode with a plurality of holes extending from one side to the other side, a second electrode inserted into each of these holes, and a separator layer arranged between the first electrode and the second electrode. Patent Literature 4 discloses that a secondary battery is produced by producing a honeycomb-type negative electrode and inserting a rod-type positive electrode covered with a separator layer into a hole in the honeycomb-type negative electrode. This rod-type positive electrode is a powder-dispersed positive electrode produced by drying a positive electrode mixture containing a positive electrode active material, a conductive additive, and a binder.

### CITATION LIST

### Patent Literature

Patent Literature 1: JP5587052B
Patent Literature 2: JP6374634B
Patent Literature 3: WO2019/187913
Patent Literature 4: JP2020-155334A

### SUMMARY OF THE INVENTION

The inventors have now found that by making a ceramic positive electrode into a columnar honeycomb structure with crystalline orientation in a predetermined direction, it is possible to provide a ceramic positive electrode that exhibits improved battery characteristics (for example, discharge rate characteristics) in a secondary battery, while having a three-dimensional structure that is suited for high capacity and high power output and can internally accommodate a plurality of negative electrodes.

Accordingly, an object of the present invention is to provide a ceramic positive electrode that exhibits improved battery characteristics (for example, discharge rate characteristics) in a secondary battery, while having a three-dimensional structure that is suited for high capacity and high power output and can internally accommodate a plurality of negative electrodes.

The present invention provides the following aspects.

### [Aspect 1]

A honeycomb-type ceramic positive electrode with a columnar honeycomb structure having a first end face, a second end face parallel to the first end face, and an outer side face perpendicular to the first end face and the second end face, and also having a plurality of holes extending from the first end face to the second end face, wherein the honeycomb-type ceramic positive electrode is composed of a lithium complex oxide sintered body in which a plurality of primary grains composed of a lithium complex oxide are bonded, and wherein when a central axis of the columnar honeycomb structure parallel to the outer side face or an axis parallel thereto is defined as a z-axis, the plurality of primary grains are oriented in a z-axis direction.

### [Aspect 2]

The honeycomb-type ceramic positive electrode according to aspect 1, wherein the plurality of primary grains are oriented at an average orientation angle of over 0° and 30° or less with respect to the z-axis.

### [Aspect 3]

The honeycomb-type ceramic positive electrode according to aspect 1 or 2, wherein the plurality of holes are compartmentalized by a latticed partition wall composed of the lithium complex oxide sintered body.

### [Aspect 4]

The honeycomb-type ceramic positive electrode according to aspect 3, wherein when the columnar honeycomb structure is planarly viewed in the z-axis direction, and one direction of the latticed partition wall is assigned to an x-axis and the other direction to a y-axis, primary grains constituting the partition wall in an x-axis direction are oriented in the x-axis direction, and primary grains constituting the partition wall in a y-axis direction are oriented in the y-axis direction.

### [Aspect 5]

The honeycomb-type ceramic positive electrode according to aspect 4, wherein the plurality of primary grains for every individual partition wall are oriented at an average orientation angle of over 0° and 30° or less with respect to the x-axis or the y-axis.

### [Aspect 6]

The honeycomb-type ceramic positive electrode according to any one of aspects 1 to 5, wherein the lithium complex oxide is lithium cobaltate.

### [Aspect 7]

A lithium-ion secondary battery, comprising:
the honeycomb-type ceramic positive electrode according to any one of aspects 1 to 6;
a plurality of negative electrodes inserted into the plurality of holes and having ends extending out from the first end face or the second end face;
a separator interposed between the honeycomb-type ceramic positive electrode and the negative electrodes;
an electrolytic solution; and
a battery container accommodating the honeycomb-type ceramic positive electrode, the negative electrodes, the separator, and the electrolytic solution.

### [Aspect 8]

The lithium-ion secondary battery according to aspect 7, wherein the negative electrodes comprise carbon.

### [Aspect 9]

The lithium-ion secondary battery according to aspect 7 or 8, wherein the separator is a ceramic separator.

### [Aspect 10]

The lithium-ion secondary battery according to any one of aspects 7 to 9, wherein the ceramic separator comprises at least one selected from the group consisting of MgO, Al₂O₃, ZrO₂, SiC, Si₃N₄, AlN, and cordierite.

### [Aspect 11]

The lithium-ion secondary battery according to any one of aspects 7 to 10, further comprising a positive electrode current collecting foil on at least one face of the first end face, the second end face, and the outer side face, excluding a face from which the negative electrodes extend out.

### [Aspect 12]

The lithium-ion secondary battery according to any one of aspects 7 to 11, further comprising a negative electrode current collecting foil on the ends of the negative electrodes extending out from the first end face or the second end face.

### BRIEF DESCRIPTION OF THE DRAWINGS

FIG. 1 is a schematic perspective view showing an example of a honeycomb-type ceramic positive electrode according to the present invention.

FIG. 2 is a cross-sectional perspective view for schematically illustrating cross sections C1 to C3 for EBSD analysis in a portion constituting a honeycomb-type ceramic positive electrode according to the present invention.

FIG. 3 is a SEM image showing an example of a cross section perpendicular to the layer face of an oriented positive electrode layer.

FIG. 4 is an EBSD image in the cross section of the oriented positive electrode layer shown in FIG. 3.

FIG. 5 is an area-based histogram showing the distribution of orientation angles of primary grains in the EBSD image shown in FIG. 4.

FIG. 6A is a schematic perspective view conceptually showing the configuration of a lithium-ion secondary battery according to the present invention.

FIG. 6B is a cross-sectional view along the 6B-6B line of the lithium-ion secondary battery shown in FIG. 6A.

### DETAILED DESCRIPTION OF THE INVENTION

### Honeycomb-Type Ceramic Positive Electrode

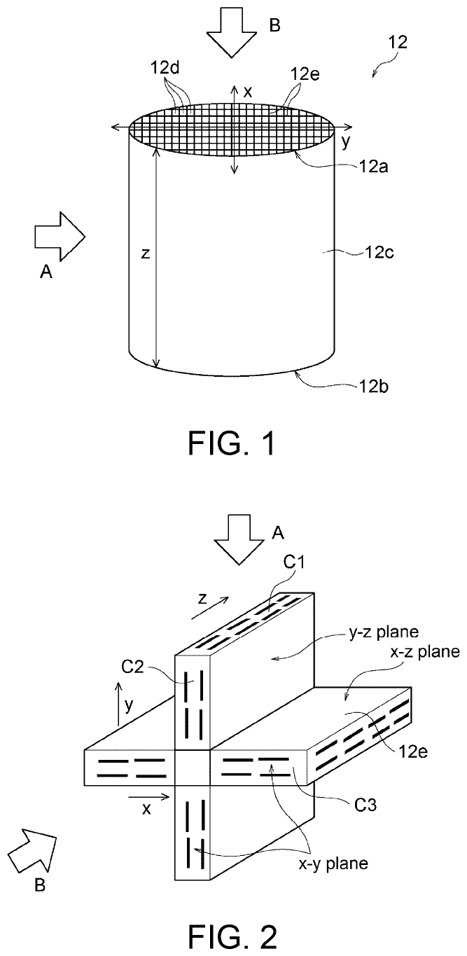

FIG. 1 shows a honeycomb-type ceramic positive electrode 12 according to an aspect of the present invention. The honeycomb-type ceramic positive electrode 12 has a columnar honeycomb structure. This columnar honeycomb structure has a first end face 12a, a second end face 12b parallel to the first end face 12a, and an outer side face 12c perpendicular to the first end face 12a and the second end face 12b. The columnar honeycomb structure also has a plurality of holes 12d extending from the first end face 12a to the second end face 12b. The honeycomb-type ceramic positive electrode 12 is composed of a lithium complex oxide sintered body. In the lithium complex oxide sintered body, a plurality of primary grains composed of a lithium complex oxide are bonded, and when the central axis of the columnar honeycomb structure parallel to the outer side face 12c or an axis parallel thereto is defined as the z-axis, the plurality of primary grains are oriented in the z-axis direction. In this way, by making the ceramic positive electrode 12 into a columnar honeycomb structure with crystalline orientation in a predetermined direction, it is possible to provide a ceramic positive electrode 12 that exhibits improved battery characteristics (for example, discharge rate characteristics) in a secondary battery, while having a three-dimensional structure that is suited for high capacity and high power output and can internally accommodate a plurality of negative electrodes.

As has been mentioned above, it is already known that capacity and charge/discharge efficiency can be improved by constituting the positive electrode or positive electrode active material layer with a lithium complex oxide sintered body (see, for example, Patent Literatures 1 and 2), and the honeycomb-type ceramic positive electrode 12 of the present invention is one in which a lithium complex oxide sintered body is made into a columnar honeycomb structure and primary grains constituting it are oriented in at least the z-axis direction. The z-axis direction corresponds to the length direction of the columnar honeycomb structure, and the orientation of primary grains in the z-axis direction facilitates the conduction of electrons and lithium ions in the z-axis direction (length direction), thereby lowering resistance in that direction. Accordingly, by inserting the negative electrodes via a separator into the holes 12d of the honeycomb-type ceramic positive electrode 12 to form a secondary battery, the battery characteristics (for example, discharge rate characteristics) can be improved.

The honeycomb-type ceramic positive electrode 12 is composed of a lithium complex oxide sintered body in which a plurality of primary grains composed of a lithium complex oxide are bonded. The fact that the positive electrode 12 is a ceramic or a sintered body means that the positive electrode 12 is free from binders or conductive additives. This is because, even if a binder is contained in a green sheet, the binder disappears or burns out during firing. Since the ceramic positive electrode 12 contains no binder, there is an advantage that deterioration of the positive electrode due to the electrolytic solution can be avoided. The lithium complex oxide constituting the sintered body is particularly preferably lithium cobaltite (typically, LiCoO₂, which may be hereinafter abbreviated as LCO). Various lithium complex oxide sintered plates or LCO sintered plates are known, and those disclosed in Patent Literature 1 (JP5587052B) and Patent Literature 3 (WO2019/187913A1) can be used, for example.

The honeycomb-type ceramic positive electrode 12 has a columnar honeycomb structure. The external shape of the columnar honeycomb structure is not specifically limited, and may be cylindrical or prismatic. In the honeycomb-type ceramic positive electrode 12, the plurality of holes 12d are preferably compartmentalized by a latticed partition wall 12e composed of the lithium complex oxide sintered body.

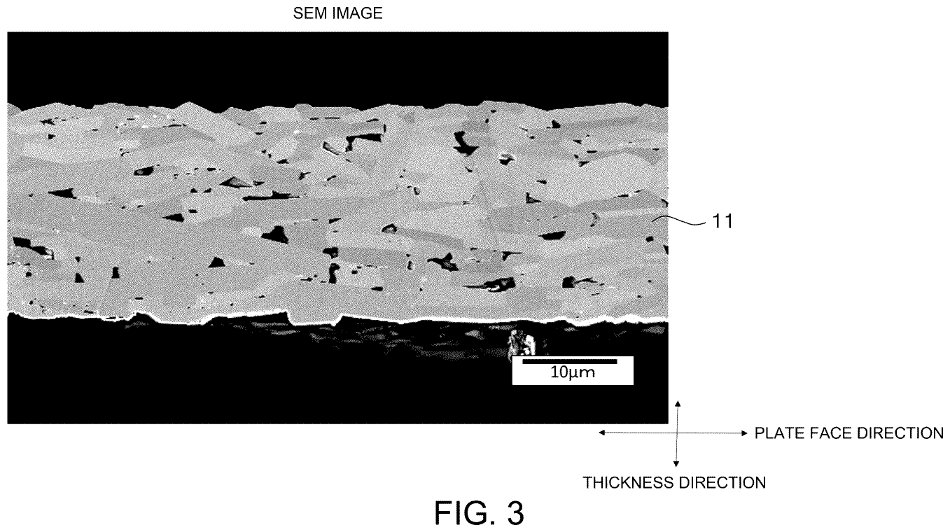

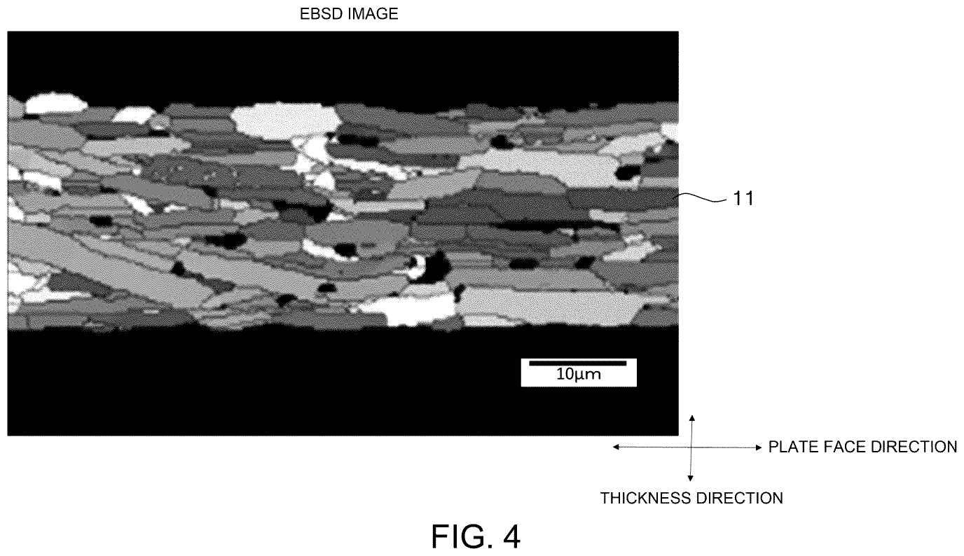

In the honeycomb-type ceramic positive electrode 12, when the central axis of the columnar honeycomb structure parallel to the outer side face 12c or an axis parallel thereto is defined as the z-axis, the plurality of primary grains are oriented in the z-axis direction. Specifically, the plurality of primary grains are preferably oriented at an average orientation angle of over 0° and 30° or less with respect to the z-axis. In order to assist understanding regarding orientation, taking an oriented positive electrode plate composed of a lithium complex oxide sintered body (see Patent Literature 3, hereinafter referred to as “oriented positive electrode layer”) as an example, the orientation morphology in the lithium complex oxide sintered body constituting the honeycomb-type ceramic positive electrode 12 (for example, partition wall 12e) will be described. FIG. 3 shows an example of a SEM image in a cross section perpendicular to the layer face of the oriented positive electrode layer, in which the average orientation angle with respect to the layer face of the oriented positive electrode layer is over 0° and 30° or less, and FIG. 4 shows an electron backscatter diffraction (EBSD: Electron Backscatter Diffraction) image in a cross section perpendicular to the plate face of the oriented positive electrode layer. Further, FIG. 4 shows an area-based histogram showing the distribution of orientation angles of primary grains 11 in the EBSD image shown in FIG. 3. In the EBSD image shown in FIG. 3, the discontinuity of crystal orientation can be observed. In FIG. 3, the orientation angle of each primary grain 11 is indicated by the shading of color. A darker color indicates a smaller orientation angle. The orientation angle is a tilt angle formed by plane (003) of the primary grains 11 to the layer face direction. In FIGS. 3 and 4, the points shown in black within the oriented positive electrode layer represent pores. The orientation morphology of the primary grains in the oriented positive electrode layer shown in FIGS. 3 to 5 is directly applicable to the lithium complex oxide sintered body constituting the honeycomb-type ceramic positive electrode 12 (for example, partition wall 12e). Accordingly, in the following description, the lithium complex oxide sintered body constituting the honeycomb-type ceramic positive electrode 12 (for example, partition wall 12e) may be referred to as oriented positive electrode layer. The measurement of the average orientation angle can be performed according to the procedure described in Examples below.

In particular, when the columnar honeycomb structure is planarly viewed in the z-axis direction, and one direction of the latticed partition wall 12e is assigned to the x-axis and the other direction to the y-axis, it is preferable that the primary grains constituting the partition wall 12e in the x-axis direction are oriented in the x-axis direction, and that the primary grains constituting the partition wall 12e in the y-axis direction are oriented in the y-axis direction. In this way, the primary grains are oriented in all of the x-axis direction, y-axis direction, and z-axis direction of the columnar honeycomb structure, and thus lower resistance is considered to be realized not only in the z-axis direction (length direction of the columnar honeycomb structure) but also in the x-axis direction and y-axis direction (that is, x-y plane direction), which further promotes lithium ion conduction and electron conduction. Also, even when the columnar honeycomb structure is lengthened, lower resistance can be realized by collecting current at the outer side face 12c. Specifically, it is preferable that the plurality of primary grains for every individual partition wall 12e are oriented at an average orientation angle of over 0° and 30° or less with respect to the x-axis or the y-axis. That is, it is preferable that the primary grains constituting the partition wall 12e parallel to the x-axis are oriented at an average orientation angle of over 0° and 30° or less with respect to the x-axis, and that the primary grains constituting the partition wall 12e parallel to the y-axis are oriented at an average orientation angle of over 0° and 30° or less with respect to the y-axis.

The honeycomb-type ceramic positive electrode 12 is an oriented sintered body composed of the plurality of primary grains 11 bound to each other. The primary grains 11 are each mainly in the form of a plate but may include rectangular, cubic, and spherical grains. The cross-sectional shape of each primary grain 11 is not particularly limited and may be a rectangular shape, a polygonal shape other than the rectangular shape, a circular shape, an elliptical shape, or a complex shape other than above.

The primary grains 11 are composed of a lithium complex oxide. The lithium complex oxide is an oxide represented by LiₓMO₂ (where 0.05<x<1.10 is satisfied, M represents at least one transition metal, and M typically contains one or more of Co, Ni, and Mn). The lithium complex oxide has a layered rock-salt structure. The layered rock-salt structure refers to a crystalline structure in which lithium layers and transition metal layers other than lithium are alternately stacked with oxygen layers interposed therebetween, that is, a crystalline structure in which transition metal ion layers and single lithium layers are alternately stacked with oxide ions therebetween (typically, an α-NaFeO₂ structure, i.e., a cubic rock-salt structure in which transition metal and lithium are regularly disposed in the axis direction). Examples of the lithium complex oxide include LiₓCoO₂ (lithium cobaltate), LiₓNiO₂ (lithium nickelate), LiₓMnO₂ (lithium manganate), LiₓNiMnO₂ (lithium nickel manganate), LiₓNiCoO₂ (lithium nickel cobaltate), LiₓCoNiMnO₂ (lithium cobalt nickel manganate), and LiₓCoMnO₂ (lithium cobalt manganate), particularly preferably LiₓCoO₂ (lithium cobaltate, typically LiCoO₂). The lithium complex oxide may contain one or more elements selected from Mg, Al, Si, Ca, Ti, V, Cr, Fe, Cu, Zn, Ga, Ge, Sr, Y, Zr, Nb, Mo, Ag, Sn, Sb, Te, Ba, Bi, and W.

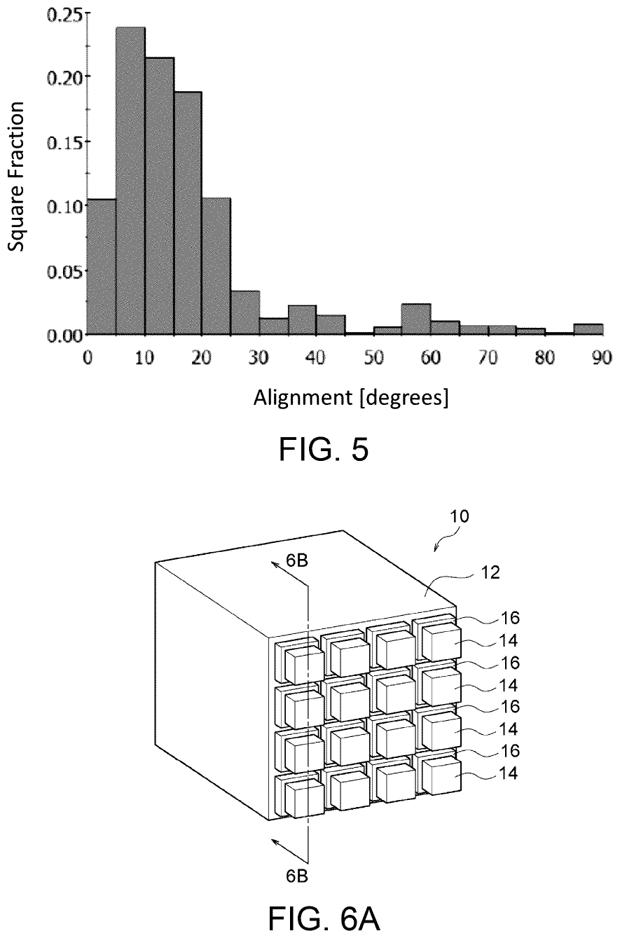

As shown in FIGS. 4 and 5, the average of the orientation angles of the primary grains 11, that is, the average orientation angle is over 0° and 30° or less. This brings various advantages as follows. First, since each primary grain 11 lies in a direction inclined from the thickness direction, the adhesion between the primary grains can be improved. As a result, the lithium ion conductivity between a certain primary grain 11 and each of other primary grains 11 adjacent to the primary grain 11 on both sides in the longitudinal direction can be improved, so that the rate characteristic can be improved. Secondly, the rate characteristic can be further improved. This is because, when lithium ions move in and out, the oriented positive electrode layer expands and contracts smoothly since the oriented positive electrode layer expands and contracts more in the thickness direction than in the layer face direction, as described above, and thus the lithium ions also move in and out smoothly.

The average orientation angle of the primary grains 11 is obtained by the following method. First, three horizontal lines that divide the oriented positive electrode layer into four equal parts in the thickness direction and three vertical lines that divide the oriented positive electrode layer into four equal parts in the layer face direction are drawn in an EBSD image of a rectangular region of 95 μm×125 μm observed at a magnification of 1000 times, as shown in FIG. 4. Next, the average orientation angle of the primary grains 11 is obtained by arithmetically averaging the orientation angles of all the primary grains 11 intersecting at least one of the three horizontal lines and the three vertical lines. The average orientation angle of the primary grains 11 is preferably 30° or less, more preferably 25° or less, from the viewpoint of further improving the rate characteristics. From the viewpoint of further improving the rate characteristics, the average orientation angle of the primary grains 11 is preferably 2° or more, more preferably 5° or more.

As shown in FIG. 5, the orientation angles of the primary grains 11 may be widely distributed from 0° to 90°, but most of them are preferably distributed in the region of over 0° and 30° or less. That is, when a cross section of the oriented sintered body constituting the oriented positive electrode layer is analyzed by EBSD, the total area of the primary grains 11 with an orientation angle of over 0° and 30° or less to the layer face of the oriented positive electrode layer (which will be hereinafter referred to as low-angle primary grains) out of the primary grains 11 contained in the cross section analyzed is preferably 70% or more, more preferably 80% or more, with respect to the total area of the primary grains 11 contained in the cross section (specifically, 30 primary grains 11 used for calculating the average orientation angle). Thereby, the proportion of the primary grains 11 with high mutual adhesion can be increased, so that the rate characteristic can be further improved. Further, the total area of grains with an orientation angle of 20° or less among the low-angle primary grains is more preferably 50% or more with respect to the total area of 30 primary grains 11 used for calculating the average orientation angle. Further, the total area of grains with an orientation angle of 10° or less among the low-angle primary grains is more preferably 15% or more with respect to the total area of 30 primary grains 11 used for calculating the average orientation angle.

Since the primary grains 11 are each mainly in the form of a plate, the cross section of each primary grain 11 extends in a predetermined direction, typically in a substantially rectangular shape, as shown in FIGS. 3 and 4. That is, when the cross section of the oriented sintered body is analyzed by EBSD, the total area of the primary grains 11 with an aspect ratio of 4 or more in the primary grains 11 contained in the cross section analyzed is preferably 70% or more, more preferably 80% or more, with respect to the total area of the primary grains 11 contained in the cross section (specifically, 30 primary grains 11 used for calculating the average orientation angle). Specifically, in the EBSD image as shown in FIG. 4, the mutual adhesion between the primary grains 11 can be further improved by above, as a result of which the rate characteristic can be further improved. The aspect ratio of each primary grain 11 is a value obtained by dividing the maximum Feret diameter of the primary grain 11 by the minimum Feret diameter. The maximum Feret diameter is the maximum distance between two parallel straight lines that interpose the primary grain 11 therebetween on the EBSD image in observation of the cross section. The minimum Feret diameter is the minimum distance between two parallel straight lines that interpose the primary grain 11 therebetween on the EBSD image.

The mean diameter of the plurality of primary grains constituting the oriented sintered body is preferably 5 μm or more. Specifically, the mean diameter of the 30 primary grains 11 used for calculating the average orientation angle is preferably 5 μm or more, more preferably 7 μm or more, further preferably 12 μm or more. Thereby, since the number of grain boundaries between the primary grains 11 in the direction in which lithium ions conduct is reduced, and the lithium ion conductivity as a whole is improved, the rate characteristic can be further improved. The mean diameter of the primary grains 11 is a value obtained by arithmetically averaging the equivalent circle diameters of the primary grains 11. An equivalent circle diameter is the diameter of a circle having the same area as each primary grain 11 on the EBSD image.

The lithium complex oxide sintered body constituting the honeycomb-type ceramic positive electrode 12 (for example, partition wall 12e) preferably includes pores. The electrolytic solution can penetrate into the sintered body by the sintered body including pores, particularly open pores, when the sintered body is integrated into a battery as a positive electrode plate. As a result, the lithium ion conductivity can be improved. This is because there are two types of conduction of lithium ions within the sintered body: conduction through constituent grains of the sintered body; and conduction through the electrolytic solution within the pores, and the conduction through the electrolytic solution within the pores is overwhelmingly faster.

The thickness of the partition wall 12e constituting the positive electrode 12 is 70 to 200 μm, preferably 80 to 100 μm, further preferably 80 to 95 μm, particularly preferably 85 to 95 μm. The thickness within such a range can improve the energy density of the lithium-ion secondary battery 10 by increasing the capacity of the active material per unit area together with suppressing the deterioration of the battery characteristics (particularly, the increase of the resistance value) due to repeated charging/discharging.

The honeycomb-type ceramic positive electrode 12 may be produced in the same manner as the known methods for producing an oriented positive electrode plate as disclosed in Patent Literatures 1 to 3, except that extrusion into a honeycomb shape is performed instead of forming into a plate shape. For example, by extruding a clayish raw material containing platy particles of a lithium complex oxide such as LiCoO₂, a dispersive medium, and a binder through a honeycomb die, the platy particles are oriented in the extrusion direction regulated by the honeycomb die, and thereby a honeycomb green body can be obtained in which the platy particles are oriented in the x-axis, y-axis, and z-axis directions. Next, the resultant honeycomb green body can be degreased and fired according to known methods, thereby obtaining the honeycomb-type ceramic positive electrode 12 composed of an oriented lithium complex oxide sintered body.

### Lithium-Ion Secondary Battery

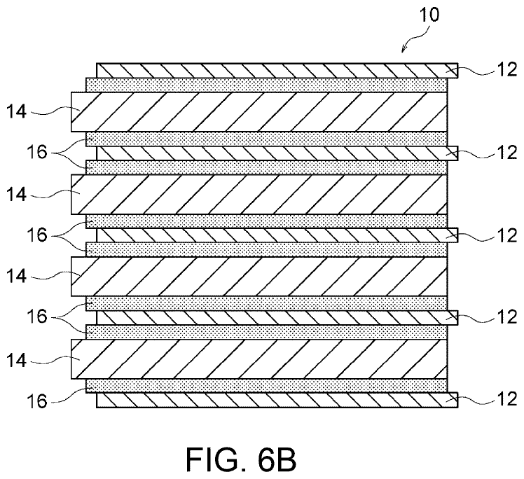

FIGS. 6A and 6B show a lithium-ion secondary battery 10 having the honeycomb-type ceramic positive electrode 12. For the sake of convenience of illustration, these figures depict only a portion of the columnar honeycomb structure that has been cut out in the shape of a square column. This secondary battery 10 has the honeycomb-type ceramic positive electrode 12, a plurality of negative electrodes 14, a separator 16, an electrolytic solution (not shown), and a battery container (not shown). The plurality of negative electrodes 14 are inserted into the plurality of holes 12d, and the ends of the negative electrodes 14 extend out from the first end face 12a or the second end face 12b. The separator 16 is interposed between the honeycomb-type ceramic positive electrode 12 and the negative electrodes 14.

The secondary battery 10 can further include a positive electrode current collecting foil and/or a negative electrode current collecting foil (not shown). In this case, the positive electrode current collecting foil is preferably provided on at least one face of the first end face 12a, the second end face 12b, and the outer side face 12c (excluding the face from which the negative electrodes 14 extend out). On the other hand, the negative electrode current collecting foil is preferably provided on the ends of the negative electrodes 14 extending out from the first end face 12a or the second end face 12b.

The negative electrodes 14 preferably contain carbon as the negative electrode active material. Examples of the carbon include graphite, pyrolytic carbon, coke, fired resin, mesophase microspheres, and mesophase pitch, with graphite being preferred. The graphite may be any of natural graphite or artificial graphite. The negative electrodes 14 preferably further contain a binder. Examples of the binder include styrene butadiene rubber (SBR), polyvinylidene fluoride (PVDF), and polytetrafluoroethylene (PTFE), with styrene butadiene rubber (SBR) or polyvinylidene fluoride (PVDF) being preferred. The size of the negative electrodes 14 is not specifically limited as long as they are of a size that can be inserted into the holes 12d of the honeycomb-type ceramic positive electrode 12 with the separator 16 interposed.

The separator 16 is preferably a ceramic separator. For example, when the surface of the honeycomb-type ceramic positive electrode 12 (in particular, partition wall 12e) and/or the surface of the negative electrodes 14 is covered with a ceramic separator, the lithium-ion secondary battery 10 can be efficiently produced by simply inserting the negative electrodes 14 into the holes 12d of the honeycomb-type ceramic positive electrode 12. The ceramic separator 16 is a microporous film made of ceramic. The ceramic contained in the ceramic separator 16 is preferably at least one selected from MgO, Al₂O₃, ZrO₂, SiC, Si₃N₄, AlN, and cordierite, more preferably at least one selected from MgO, Al₂O₃, and ZrO₂. The ceramic separator 16 preferably has a thickness of 1 to 40 μm, more preferably 2 to 30 μm, further preferably 3 to 20 μm. Alternatively, the separator 16 may be a polymeric microporous film. In this case, the separator 16 is preferably a separator made of polyolefin, polyimide, polyester (for example, polyethylene terephthalate (PET)), or cellulose. Examples of the polyolefin include polypropylene (PP), polyethylene (PE), and combinations thereof.

The electrolytic solution is not specifically limited, and commercially available electrolytic solutions for lithium batteries such as a solution obtained by dissolving a lithium salt (e.g., LiPF₆) salt in an organic solvent (e.g., a mixed solvent of ethylene carbonate (EC) and methyl ethyl carbonate (MEC), a mixed solvent of ethylene carbonate (EC) and diethyl carbonate (DEC), or a mixed solvent of ethylene carbonate (EC) and ethyl methyl carbonate (EMC)) may be used.

The lithium-ion secondary battery 10 having the honeycomb-type ceramic positive electrode 12 may be produced by any production method. For example, the separator 16 may be formed in advance on the surface of the negative electrodes 14, and the negative electrodes 14 covered with the separator 16 may be inserted into the holes 12d of the honeycomb-type ceramic positive electrode 12. In this case, the formation of the separator 16 on the surface of the negative electrodes 14 can be performed by applying (for example, by dip coating) a slurry containing a ceramic powder (for example, MgO powder), a binder, a dispersive medium, and the like to the negative electrodes 14 and drying it. Alternatively, the separator 16 may be formed on the surface of the partition wall 12e of the honeycomb-type ceramic positive electrode 12, and the rod-shaped negative electrodes 14 may be inserted into the holes 12d. In this case, instead of inserting the rod-shaped negative electrodes 14, a slurry containing a negative electrode active material (for example, graphite slurry) may be poured into the holes 12d to form the negative electrodes 14. At this time, it is preferable from the viewpoint of current collection to form extending-out portions of the negative electrodes 14 by overfilling the slurry so that it protrudes from the holes 12d.

The current collection structure in the lithium-ion secondary battery 10 is not specifically limited either. For example, while allowing the negative electrodes 14 to extend out only from the first end face 12a (or second end face 12b) of the honeycomb-type ceramic positive electrode 12, a negative electrode current collector (for example, current collecting foil) may be attached to the extending-out portions of the negative electrodes 14 and a positive electrode current collector (for example, current collecting foil) may be attached to the other second end face 12b (or first end face 12a) and/or the outer side face 12c of the honeycomb-type ceramic positive electrode 12. In this case, the secondary battery 10 is preferably configured so that the negative electrodes 14 do not reach the second end face 12b (or first end face 12a) to which the positive electrode current collector is to be attached.

### EXAMPLES

The invention will be illustrated in more detail by the following examples.

### Example 1

### (1) Production of Positive Electrode

A honeycomb-type ceramic positive electrode was produced by the following procedure.

### (1a) Preparation of Forming Raw Material

Co₃O₄ powder (manufactured by SEIDO CHEMICAL INDUSTRY CO., LTD.) and Li₂CO₃ powder (manufactured by THE HONJO CHEMICAL CORPORATION) weighed to a molar ratio Li/Co of 1.01 were mixed, and thereafter the mixture was kept at 780° C. for 5 hours. The resultant powder was milled and crushed into a volume-based D50 of 0.4 μm with a pot mill to yield LiCoO₂ raw material powder. This LiCoO₂ raw material powder (100 parts by weight), a dispersive medium (toluene:isopropanol=1:1) (30 parts by weight), a binder (polyvinyl butyral: Product No. BM-2, manufactured by SEKISUI CHEMICAL CO., LTD.) (10 parts by weight), a plasticizer (DOP: Di(2-ethylhexyl) phthalate, manufactured by Kurogane Kasei Co., Ltd.) (4 parts by weight), and a dispersant (product name: RHEODOL SP-O30, manufactured by Kao Corporation) (2 parts by weight) were mixed to yield a clayish forming raw material.

### (1b) Forming

The resulting forming raw material was extruded to obtain a honeycomb green body. The dimensions of the die were a honeycomb shape with a wall thickness of 100 μm and a pitch of 2.0 mm. The area of the die was about 20×20 mm. The resultant honeycomb green body was cut to a length of 50 mm.

### (1c) Firing

After raising the temperature to 600° C. at a temperature increase rate of 200° C./h and degreasing for 3 hours, the resultant honeycomb green body was placed in an alumina sheath (manufactured by Nikkato Corporation). In the closed sheath, the temperature was raised to 920° C. at 200° C./h and then kept for 4 hours. The resultant honeycomb structure was densely sintered to yield a honeycomb-type oriented ceramic positive electrode with a wall thickness of 100 μm and a pitch of 2.0 mm.

### (2) Production of Negative Electrodes

To 100 parts by weight of synthetic graphite (SCMG-CF manufactured by Showa Denko K.K.) and 10 parts by weight of PTFE (Polyflon D-1E manufactured by Daikin Industries, Ltd.), 30 parts by weight of isopropanol (manufactured by FUJIFILM Wako Pure Chemical Corporation) were added, and the mixture was kneaded and extruded through a die with dimensions of 1.9×1.9 mm to yield a rectangular-shaped negative electrode. By drying it under reduced pressure (−95 kPa, 80° C., 16 h) and cutting it into a length of 50 mm, rectangular-shaped negative electrodes were produced.

### (3) Production of Separator

Magnesium carbonate powder (manufactured by Konoshima Chemical Co., Ltd.) was heat-treated at 900° C. for 5 hours to obtain MgO powder. This powder (100 parts by weight), a dispersive medium (toluene:isopropanol=1:1) (100 parts by weight), a binder (polyvinyl butyral: Product No. BM-2, manufactured by SEKISUI CHEMICAL CO., LTD.) (20 parts by weight), a plasticizer (DOP: Di(2-ethylhexyl) phthalate, manufactured by Kurogane Kasei Co., Ltd.) (4 parts by weight), and a dispersant (product name: RHEODOL SP-O30, manufactured by Kao Corporation) (2 parts by weight) were mixed. With the resultant coating material, the aforementioned rectangular-shaped negative electrode was dip-coated up to 49 mm of the 50 mm in the length direction, and then vacuum-dried (−95 kPa, 100° C., 2 h) to form a separator film on the surface of the rectangular-shaped negative electrode.

### (4) Production of Conductive Adhesive

Acetylene black and polyimide amide were weighed to a mass ratio of 3:1 and mixed with an appropriate amount of NMP (N-methyl-2-pyrrolidone) as a solvent, to prepare a conductive carbon paste as a conductive adhesive.

### (5) Production of Battery

The rectangular-shaped negative electrode on which the MgO separator has been formed is inserted into each of the holes with a pitch of 2.0 mm formed in the above honeycomb-type ceramic positive electrode. The insertion into the honeycomb-type ceramic positive electrode is up to 49 mm where the separator is formed. Next, using the conductive adhesive produced, a copper foil with a thickness of 10 μm is attached to the end faces of the negative electrodes in the 1 mm portion protruding from the honeycomb structure. Also, to the end face of the honeycomb-type ceramic positive electrode where the negative electrodes did not protrude, a 15 μm aluminum foil was attached using the conductive adhesive. This structure was enclosed in a glass cell provided with current collecting sections, filled with an electrolytic solution, and closed to form a battery. The electrolytic solution used was obtained by dissolving LiPF₆ in an organic solvent of ethylene carbonate (EC) and ethyl methyl carbonate (EMC) mixed at a volume ratio of 3:7 to a concentration of 1.0 mol/L and further adding 2 parts by weight of vinylene carbonate as an additive.

### (6) Evaluation

The following evaluations were performed on the produced honeycomb-type ceramic positive electrode and battery.

### <Average Orientation Angle of Primary Grains>

The average orientation angles of the primary grains, which constitute the honeycomb-type ceramic positive electrode, oriented in the respective directions of the x-axis, y-axis and z-axis were measured as follows.

(i) Average Orientation Angle Regarding Orientation in z-Axis Direction

The honeycomb-type ceramic positive electrode was polished from the direction of the arrow A shown in FIG. 1 using cross-section polisher (CP) (manufactured by JEOL Ltd., IB-15000CP). As shown in FIGS. 1 and 2, an exposed LiCoO₂ layer cross section parallel to the x-z plane (hereinafter referred to as “cross section C1”) was subjected to EBSD measurement in a 1000× field of view (125 μm×125 μm) to obtain an EBSD image. This EBSD measurement was performed using a Schottky field emission scanning electron microscope (manufactured by JEOL Ltd., model JSM-7800F). For all grains identified in the obtained EBSD image, the angle formed by the (003) plane of the primary grains and the z-axis (or y-z plane) (that is, the tilt of crystal orientation from (003)) was determined as the tilt angle, and the average value of these angles was taken as the average orientation angle of the primary grains with respect to the z-axis in the cross section C1.

(ii) Average Orientation Angle Regarding Orientation in y-Axis Direction or x-Axis Direction

The honeycomb-type ceramic positive electrode was polished from the direction of the arrow B shown in FIG. 1 using cross-section polisher (CP) (manufactured by JEOL Ltd., IB-15000CP). As shown in FIGS. 1 and 2, the portion corresponding to the partition wall parallel to the y-axis in an exposed latticed LiCoO₂ layer cross section parallel to the x-y plane (hereinafter referred to as “cross section C2”) was subjected to EBSD measurement in a 1000× field of view (125 μm×125 μm), in the same manner as described above, to obtain an EBSD image. For all grains identified in the obtained EBSD image, the angle formed by the (003) plane of the primary grains and the y-axis (or y-z plane) (that is, the tilt of crystal orientation from (003)) was determined as the tilt angle, and the average value of these angles was taken as the average orientation angle of the primary grains with respect to the y-axis in the cross section C2. Also, the portion corresponding to the partition wall parallel to the x-axis in the exposed latticed LiCoO₂ layer cross section parallel to the x-y plane (hereinafter referred to as “cross section C3”) was subjected to EBSD measurement in a 1000× field of view (125 μm×125 μm), in the same manner as described above, to obtain an EBSD image. For all grains identified in the obtained EBSD image, the angle formed by the (003) plane of the primary grains and the x-axis (or x-z plane) (that is, the tilt of crystal orientation from (003)) was determined as the tilt angle, and the average value of these angles was taken as the average orientation angle of the primary grains with respect to the x-axis in the cross section C3.

### <Discharge Rate Characteristics>

The discharge capacity retention rate as discharge rate characteristics of the battery was measured in the voltage range of 3.0 to 4.3 V using the following procedure. That is, the battery was charged at a constant current of a 0.2 C rate until the battery voltage reached 4.3 V, subsequently charged at a constant voltage until the current value reached a 0.02 C rate, and then discharged at a constant current of a 0.2 C discharge rate until the battery voltage reached 3.0 V, thus measuring the 0.2 C discharge capacity. For this discharged battery, charging was performed in the same manner as described above, followed by discharging at a constant current of a 0.5 C discharge rate until the battery voltage reached 3.0 V. For this discharged battery, charging was performed again in the same manner as described above, followed by discharging at a constant current of a 1.0 C discharge rate until the battery voltage reached 3.0 V, thus measuring the 1.0 C discharge capacity. By dividing the 1.0 C discharge capacity by the 0.2 C discharge capacity and multiplying it by 100, the discharge capacity retention rate (%) was calculated.
Evaluation A: The discharge capacity retention rate is 80% or more.
Evaluation B: The discharge capacity retention rate is 70% or more and less than 80%.
Evaluation C: The discharge capacity retention rate is less than 70%.

### Example 2 (Comparison)

Production and evaluation of a battery were performed in the same manner as in Example 1, except that a non-oriented honeycomb-type ceramic positive electrode was produced using LiCoO₂ raw material powder produced without milling and crushing in (1a) of Example 1.

### Results

The evaluation results obtained in Examples 1 and 2 were as follows.

TABLE 1

| | Cross section C1 | Cross section C2 | Cross section C3 | Discharge |
|---|---|---|---|---|
| | Average orientation | Average orientation | Average orientation | capacity |
| | angle with respect to | angle with respect to | angle with respect to | retention |
| | z-axis (y-z plane) | y-axis (y-z plane) | x-axis (x-z plane) | rate |
| Ex. 1 | 15° | 15° | 15° | A |
| Ex. 2* | Non-oriented | Non-oriented | Non-oriented | B |
| | (random) | (random) | (random) | |

The symbol * indicates a comparative example.

As shown in Table 1, the battery of Example 1, which uses a honeycomb-type ceramic positive electrode oriented at an average orientation angle of 15°, exhibited a more excellent discharge capacity retention rate compared to the battery of Example 2 (comparative example), which uses a non-oriented honeycomb-type ceramic positive electrode. This is considered to be because, in the honeycomb-type ceramic positive electrode adopted in Example 1, the LiCoO₂ particles are oriented in the extrusion direction (z-axis direction) at the time of extrusion and are also oriented in the plane direction perpendicular to the extrusion direction (x-y plane direction) due to the honeycomb lattice structure, and as a result, lower resistance is realized in the three directions of x-axis direction, y-axis direction and x-axis direction, thereby promoting lithium ion conduction and electron conduction.

What is claimed is:

1. A honeycomb-type ceramic positive electrode with a columnar honeycomb structure having a first end face, a second end face parallel to the first end face, and an outer side face perpendicular to the first end face and the second end face, and also having a plurality of holes extending from the first end face to the second end face,
wherein the honeycomb-type ceramic positive electrode is composed of a lithium complex oxide sintered body in which a plurality of primary grains composed of a lithium complex oxide are bonded, and
wherein when a central axis of the columnar honeycomb structure parallel to the outer side face or an axis parallel thereto is defined as a z-axis, the plurality of primary grains are oriented in a z-axis direction.

2. The honeycomb-type ceramic positive electrode according to claim 1, wherein the plurality of primary grains are oriented at an average orientation angle of over 0° and 30° or less with respect to the z-axis.

3. The honeycomb-type ceramic positive electrode according to claim 1, wherein the plurality of holes are compartmentalized by a latticed partition wall composed of the lithium complex oxide sintered body.

4. The honeycomb-type ceramic positive electrode according to claim 3, wherein when the columnar honeycomb structure is planarly viewed in the z-axis direction, and one direction of the latticed partition wall is assigned to an x-axis and the other direction to a y-axis, primary grains constituting the partition wall in an x-axis direction are oriented in the x-axis direction, and primary grains constituting the partition wall in a y-axis direction are oriented in the y-axis direction.

5. The honeycomb-type ceramic positive electrode according to claim 4, wherein the plurality of primary grains for every individual partition wall are oriented at an average orientation angle of over 0° and 30° or less with respect to the x-axis or the y-axis.

6. The honeycomb-type ceramic positive electrode according to claim 1, wherein the lithium complex oxide is lithium cobaltate.

7. A lithium-ion secondary battery, comprising:
the honeycomb-type ceramic positive electrode according to claim 1;
a plurality of negative electrodes inserted into the plurality of holes and having ends extending out from the first end face or the second end face;
a separator interposed between the honeycomb-type ceramic positive electrode and the negative electrodes;
an electrolytic solution; and
a battery container accommodating the honeycomb-type ceramic positive electrode, the negative electrodes, the separator, and the electrolytic solution.

8. The lithium-ion secondary battery according to claim 7, wherein the negative electrodes comprise carbon.

9. The lithium-ion secondary battery according to claim 7, wherein the separator is a ceramic separator.

10. The lithium-ion secondary battery according to claim 7, wherein the ceramic separator comprises at least one selected from the group consisting of MgO, Al₂O₃, ZrO₂, SiC, Si₃N₄, AlN, and cordierite.

11. The lithium-ion secondary battery according to claim 7, further comprising a positive electrode current collecting foil on at least one face of the first end face, the second end face, and the outer side face, excluding a face from which the negative electrodes extend out.

12. The lithium-ion secondary battery according to claim 7, further comprising a negative electrode current collecting foil on the ends of the negative electrodes extending out from the first end face or the second end face.
